(19) United States
(12) Patent Application Publication
(10) Pub. No.: US 2002/0063743 A1
(43) Pub. Date: May 30, 2002

(54) Ink jet printing of multifarious postage information

(75) Inventors: Lawrence F. Eisner, Harwinton, CT (US); Thomas A. Herrmann, Easton, CT (US)

Correspondence Address: NIXON & VANDERHYE P.C., 8th Floor, 1100 North Glebe Road, Arlington, VA, 22201, US

(73) Assignee: BRYCE OFFICE SYSTEMS

(21) Appl. No.: 10/051,308

(22) Filed: Jan. 22, 2002

Related U.S. Application Data
(63) Continuation-in-part of application No. 09/507,923, filed on Feb. 22, 2000.
(60) Provisional application No. 60/122,383, filed on Mar. 5, 1999.

(51) Int. Cl. B41J 3/00

(52) U.S. Cl. 347/2

(57) ABSTRACT

A method and apparatus print multifarious postage information on mailing media in an entirely variable manner so that any one of postage or postal permit information, or return address, and graphics, may be changed on the fly and printed in an appropriate location adjacent the top edge of a piece of mailing media such as an envelope. The method may be practiced at a rate of at least 100 pieces of mailing media per minute, and can be practiced to print media having variable thickness ranging from single thickness sheets or labels to stuffed envelopes. The apparatus is very simple comprising an ink jet printer with at least one ink jet head, a feeder which feeds mailing media pieces one at a time into printing position with the ink jet heads, and an external computer (that may have an optical sensor for sensing the leading edge of the media associated therewith) which controls the ink jet printer and feeder.

### RELATED APPLICATIONS

This application is a continuation-in-part of application Ser. No. 09/507,923, filed Feb. 22, 2000 and which in turn is based upon provisional application Serial No. 60/122,383 filed Mar. 2, 1999, the disclosures of which are incorporated herein by reference herein.

### BACKGROUND OF THE INVENTION

Currently there are a number of different devices that are capable of printing postal information near the top of a piece of mailing media. They include: mailing (franking) machines, stamp-canceling machines, return address printing systems, etc. These systems may depend on mechanical ink transfer systems to print on the media. Such a system uses a rotary drum with an engraved image. The drum is inked, and pressed on the mailing media to print the image. These postage-printing systems typically include an integrated secure postage-metering device that dispenses and records the use of prepaid, or to-be-paid postage. While some of these closed (integrated) systems rely on rotary drum for printing, others may use ink jet or thermal transfer printing technology.

This invention uses a single, or a plurality, of ink jet print heads to perform the multifarious postal printing functions. The device is specifically designed to automatically print information in the location(s) specified by the user, as required by governing postal authorities. When the application calls for the secured metering of postage, the metering is performed by an independent system that interfaces with the computer that sends the required image to the device. A transport system moves the mailing media under the print head(s) which are placed so that the imaging area will be a band across the top edge of the media as required by postal regulations. The system is connected to a computer that provides the appropriate image to the system via a conventional computer-printer interface. The computer interface may also be relied upon to print bulk rate postage permits, FIM postal codes, return address information and messages.

In conventional mailing (franking) machines, and stamp canceling machines, in the prior art, the only part of the printing of an envelope that is variable is the date and the amount of postage. The date is variable only by batch since the date is changed by a manual typeset adjustment, and the postage cannot be varied from one envelope or other mailing piece to another on the fly. If a logo is printed from the systems representing the conventional prior art it must be formed from a fixed engraved printing drum, and thus is not variable within a batch of mail, or on the fly. Changing logos between batches is comparatively difficult and time consuming since each logo requires a different engraved plate or drum. Also return addresses are typically not printable by prior art systems because they have a limited print area, typically four inches or so from the left (trailing) edge of the mailing piece.

The invention is also much more versatile than conventional desk top printers, and can print mailing pieces at a much higher speed. Typical desk top printers can only print on empty envelopes of a limited size range, and typically the printing rate is about ten pieces per minute. However according to the invention it is possible to print on stuffed mailing media, virtually any size approved by the postal authorities, due to the open design of the system and method of the invention. Also the invention is capable of printing at least about 100 pieces of mailing media per minute, typically at least about 200, and even in excess of 250 pieces (e.g. envelopes) per minute.

### BRIEF DESCRIPTION OF THE INVENTION

According to the present invention there is provided a method of printing multifarious postage information on mailing media having a top edge and left and right edges, using an ink jet printer with first and second ink jet heads, a feeder, and a computer for controlling the ink jet printer and feeder, comprising (a), by computer control of the feeder, automatically feeding mailing media pieces one at a time to the ink jet printer so that the top, left and right edges of the mailing media are positioned in printing relationship with the at least one ink jet head, (b), by computer control of the ink jet printer, variably printing at least two of postage or postal permit information, a return address, and graphics in appropriate locations adjacent the top edge of the mailing media and (c), arranging the first and second ink jet heads contiguously to one another to print on respective different areas along the mailing media pieces spaced from one another in a direction generally perpendicular to the top edges thereof so that a combined printed area is greater than the printed area of each of the print heads individually.

Preferably (b) is practiced to variably print all of a return address, graphics, and either postage or postal permit information. Also preferably (a) and (b) are practiced at a rate of at least 100 pieces of mailing media per minute (e.g. to print stuffed envelopes as the mailing media at a rate of at least 200 envelopes per minute, and even to print mailing media in excess of 250 pieces per minute). Also desirably (b) is practiced to print substantially anywhere between the left and right edges of the mailing media pieces adjacent the top edge thereof, and (a) and (b) are practiced to print media having variable thickness ranging from single thickness sheets or labels to stuffed envelopes.

The invention is particularly advantageous because (a) may be practiced to substantially continuously feed the mailing media, and (b) can be practiced to change at least one of the return address, graphics, or postage or postal permit information, on the fly, so that one piece of mailing media has different indicia adjacent the top edge thereof than a leading or trailing piece of mailing media continuously fed during the practice of (a).

Also (b) may be practiced to print mailing media pieces of different size by referencing the leading and top edges of the mailing media pieces, and (a) and (b) may be further practiced so that the leading edge of each of the mailing media pieces is the right edge thereof.

Further, (c) may be practiced such that the print head nozzles of the first ink jet head are spaced from the nozzles of the second ink jet head a distance corresponding to the spacing between the nozzles of the heads or the first and second ink jet heads have certain nozzles which overlap the nozzles of the other ink jet head. The internal computer controls the overlapping nozzles to disable those nozzles. In this manner, a substantially wider area of printing is provided, for example, between 1 to 1.5 inches, by employing two conventional print heads in contiguous or overlapping relation in a direction away from the top edge of the mailing media pieces. Consequently, a wider coverage along the mailing media pieces is provided, enabling a wide variety of different information to be printed in accordance with customer needs.

According to another aspect of the present invention there is provided a method of printing multifarious postage information on mailing media having a top edge and left and right edges, using an ink jet printer with at least one wide ink jet head whereby an area up to 1.5 inches from the top edge of the mailing piece media may be printed, a feeder, and a computer for controlling the ink jet printer and feeder, comprising (a), by computer control of the feeder, substantially continuously automatically feeding mailing media pieces one at a time to the ink jet printer so that the top, left and right edges of the mailing media are positioned in printing relationship with the at least one ink jet head, (b), by computer control of the ink jet printer, printing at least one of postage or postal permit information, a return address, and graphics adjacent the top edge of the mailing media so as to change at least one of the return address, graphics, or postage or postal permit information, on the fly so that one piece of mailing media has different indicia adjacent the top edge thereof than a leading or trailing piece of mailing media continuously fed during the practice of (a), and (c), arranging the first and second ink jet heads contiguously to one another to print on respective different areas spaced from one another along the mailing media pieces in a direction generally perpendicular to the top edges thereof so that a combined printed area is greater than the printed area of each of the print heads individually. Preferably, the print heads overlap one another so that the exact mechanical registration is not required between adjacent print heads. The details of the procedures are preferably as described above.

According to another aspect of the present invention there is provided an apparatus for practicing the method as described above. For example according to one aspect of the invention there is provided an apparatus for printing multifarious postage information on mailing media having a top edge and left and right edges, comprising: An ink jet printer with at least one ink jet head. A feeder which feeds mailing media pieces one at a time into operative printing position with respect to the at least one ink jet head. And, an external computer (such as a conventional PC) for controlling the ink jet printer and feeder so as to print at least two of postage (for example connected up to a secure system through a global computer network (“Internet”) or a PSD) or postal permit information, a return address, and graphics at appropriate locations adjacent the top edge of the mailing media pieces.

Also the apparatus preferably further comprises a thickness adjustment for adjusting the ink jet printer to accommodate mailing media pieces ranging in thickness from substantially flat labels or sheets to stuffed envelopes; and a sensor for sensing the leading and top edges of the mailing media to provide information to the computer to thereby properly control the location of printing on the mailing media. Also, the printer, feeder, and computer are all capable of printing mailing media at a rate of at least 100 pieces per minute, and the computer controls the printer to print all of graphics, return address, and either postage or postal code information, on each pieces of mailing media with at least one different from one piece to the next while being continuously fed by the feeder.

It is the primary object of the present invention to provide a simple yet effective method and apparatus for printing multifarious postage information on a wide variety of different types of mailing media. This and other objects of the invention will become clear from an inspection of the detailed description of the invention and from the appended claims.

### BRIEF DESCRIPTION OF THE DRAWINGS

FIG. 1 is a schematic illustration of conventional prior art apparatus over which the invention is an improved;

FIG. 2 is a schematic representation of an exemplary apparatus according to the present invention for practicing the method of the present invention;

FIG. 3 is a control diagram illustrating the use of the system of FIG. 2;

FIG. 4 is a top plan view of an exemplary mailing piece according to the present invention having multifarious postage information printed thereon;

FIG. 5 is a schematic representation of a wide print head in conjunction with a mailing media piece;

FIG. 6 is a view similar to FIG. 5 illustrating contiguous print heads; and

FIG. 7 is a view similar to FIG. 6 illustrating a pair of contiguous print heads with nozzle overlap.

### DETAILED DESCRIPTION OF THE INVENTION

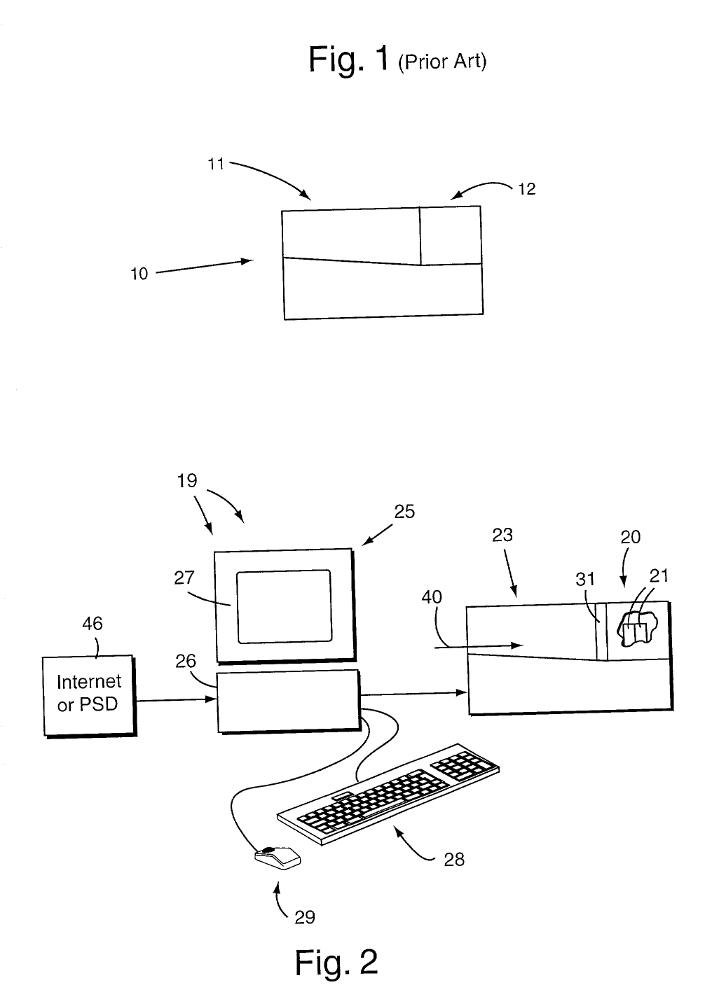

An exemplary prior art apparatus for applying postage to mailing media, such as envelopes, labels, insert sheets to be visible through shrink wrap plastic, carton blanks, etc., is illustrated schematically at 10 in FIG. 1 and includes a conventional feeder 11 and a conventional postage meter 12. These systems may depend on mechanical ink transfer systems to print on the media. Such a system uses a rotary drum with an engraved image. The drum is inked, and pressed on the mailing media to print the image. These postage printing systems typically included an integrated secure metering device that dispenses and records the use of prepaid, or to be paid, postage. While some of these closed (integrated) systems rely on a rotary drum for printing, others may use ink jet printing technology.

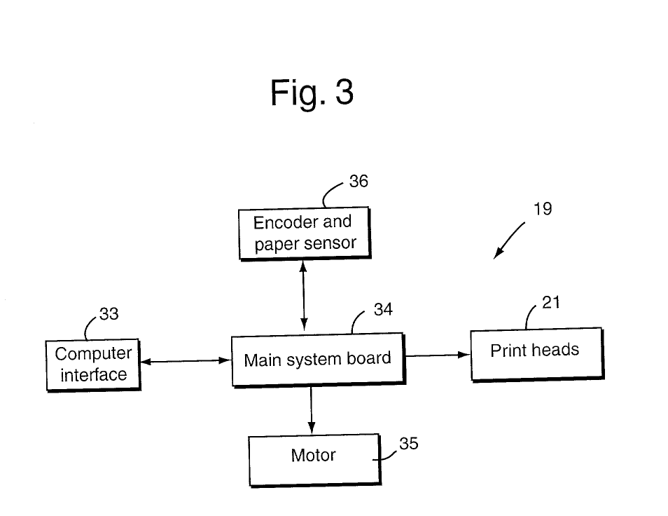

Conventional equipment such as illustrated in FIG. 1, and stamp canceling prior art equipment, is only capable of printing static text, and the only thing that can be variable is the date and amount of postage. However at least the date is changeable only by stopping operation of equipment and between batches since the date is changed by a manual typeset adjustment. If a logo (graphics) is provided it must be from a fixed engraved printing drum or the like and thus not variable on the fly. Changing logos (graphics) between batches is comparatively difficult and time consuming since each logo requires a different engraved drum. Return addresses are also typically not printable by such systems because they have limited print area, typically only four inches or so from the left edge. An apparatus according to the present invention is illustrated schematically in FIGS. 2 and 3. The apparatus includes an ink jet printer, shown schematically at 20, with at least one ink jet head, two such heads being illustrated schematically at 21 in FIG. 2. The ink jet heads may be of the type shown in U.S. Pat. Nos. 5,392,063, 5,138,342, 5,392,063, 5,094,554, 4,736,213, 5,642,143, 4,872,026, and 5,163,669, the disclosures of which are hereby incorporated by reference herein.

The apparatus 19 of FIGS. 2 and 3 also includes a feeder 23, which may be of any conventional suitable design such as shown per se in U.S. Pat. Nos. 5,094,554 and 5,326,181, the disclosures of which are hereby incorporated by reference herein, and feeds the mailing media (such as envelopes) one at a time to the ink jet printer 20 and at such a speed and in such a manner so as to allow effective printing of the indicia that is desirably printed using the ink jet heads 21.

The apparatus 19 also comprises an external computer, shown schematically at 25 in FIG. 2, and including a conventional box 26 that includes a microprocessor or the like, a monitor 27, and one or more input devices such as the conventional keyboard 28 and/or mouse 29 illustrated in FIG. 2. For example the computer 25 may be a conventional personal computer, either desk top or lap top.

The feeder 23 and/or printer 20 preferably have a thickness adjustment 31 for adjusting the printer 20 to accommodate mailing media pieces ranging in thickness from substantially flat labels or sheets to stuffed envelopes. The thickness adjustment 31 may be of any conventional arrangement which may be implemented either by manually or automatically moving the print heads 21 up and down in response to thickness (see U.S. Pat. No. 4,872,026, the disclosure of which is hereby incorporated by reference herein), or by moving the transport up and down in response to thickness variations (see U.S. Pat. Nos. 5,401,013 and 5,163,669, the disclosures of which are hereby incorporated by reference herein).

FIG. 3 is a control schematic of the equipment 19, for the printer 20 and feeder 23. The computer interface 33 is provided to interface with the computer box 26, and a main system circuit board 34 is provided which controls the motor 35 for the feeder 23 (and any conveyor downstream of the printer 20), fires the print heads 21, and operatively communicates with the encoder and paper sensor 36. The element 36 preferably includes an optical or mechanical sensor which senses the leading and top edges of the mailing media to provide information to the computer 25 through the interface 33 to thereby properly control the location of printing on the mailing media with the print heads 21.

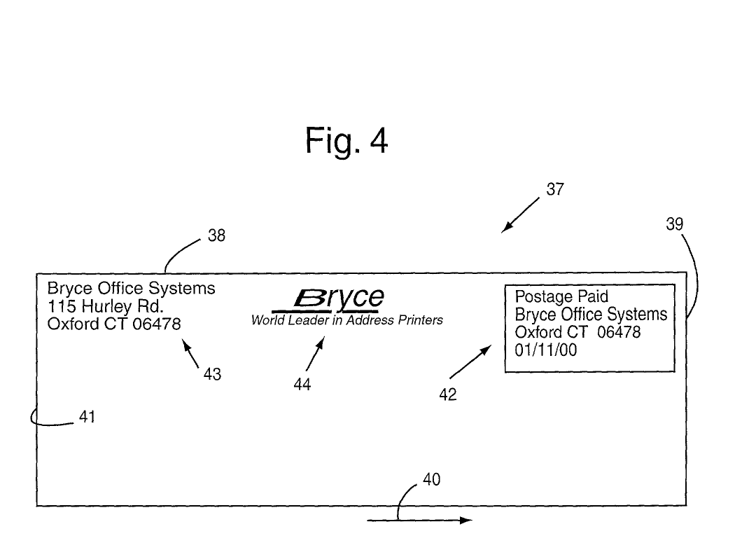

FIG. 4 illustrates an exemplary mailing media piece 37 according to the present invention, in this case a standard business size envelope, which has a top edge 38, a right edge 39 which preferably is the leading edge in the direction of transport of the mailing media by the feeder 23 to the ink jet printer 20 in the direction 40, and a left or trailing edge 41. The apparatus 19, according to the present invention, is capable of printing at least two of, and preferably all of, postage, or postal permit information 42 (see FIG. 4), a return address 43, and graphics 44, all adjacent the top edge 38 and in the proper position. That is in accordance with standard USPS criteria the postage or postal permit information 42 is printed adjacent both the top edge 38 and the right edge 39, the return address 43 is printed adjacent both the top edge 38 and the left edge 41, and the graphics 44 is printed intermediate the indicia 42, 43 and adjacent the top edge 38.

Where postage is to be printed instead of the postal permit information 42, the postage may be stored and metered from any number of different computer controlled conventional postal systems, such as the United States Postal Service IBIP System, etc. Only when actual postage is being printed instead of the postal permit information 42, is it necessary to provide the computer 25 with the secure postage, for example from the system 46 illustrated in FIG. 2, connected up to the secure postage system via a global computer network (the Internet), or connected up to a PSD System.

A very significant advantage according to the present invention is that it is possible to not only print each of the different types of indicia 42-44 that are illustrated in FIG. 4, but they all can be variable and printed “on the fly”, that is without the requirement for stopping the equipment and changing a drum, or any other adjustment feature. Rather one piece 37 could be printed, for example, with the particular indicia 42-44 illustrated in FIG. 4, and the next piece 37, without in any way significantly arresting the operation of the equipment, could have every single character of all of the different indicias 42-44 different. Whatever information one needs to provide as the indicia 42-44 may be readily input into the computer 25 using the input devices 28, 29, a conventional optical scanner, or any other conventional input device.

Utilizing the apparatus 19 according to the present invention it is possible to print multifarious postage information on mailing media, such as the envelope 37, having a top edge 38, right edge 39, and left edge 41. The method may be practiced by: (a) Computer controlling the feeder 23 to automatically feed mailing media pieces 37 one at a time to the ink jet printer 20 so that the top 38, right 39, and left 41 edges are positioned in printing relationship with the one or more ink jet heads 21; and (b) by computer control of the ink jet printer 20 (using computer 25) variably printing at least two of postage or postal permit information 42, return address 43, and graphics 44, in appropriate locations adjacent the top edge of the mailing media 37.

Preferably (b) is practiced to variably print all of the indicia 42-44 on the mailing media pieces 37, and at a rate of at least 100 pieces of mailing media per minute, typically at least 200 pieces, and preferably in excess of 250 pieces per minute. For example according to the invention it is possible to print stuff envelopes as the mailing media, and at a rate of at least 200 envelopes per minute.

Also preferably (b) is practiced to print substantially anywhere between the left and right edges 41, 39 of the mailing media piece 37 adjacent the top edge 38 thereof, and to print media having variable thicknesses ranging from single thickness sheets or labels to stuffed envelopes.

Typically (a) is practiced to substantially continuously feed the mailing media 37 in the direction 40, and (b) is practiced to change at least one of the return address 43, graphics 44, or postage or postal permit information 42, on the fly, so that one piece of mailing media 37 has different indicia adjacent the top edge 38 thereof then a leading or trailing piece of mailing media 37 in the direction 40 continuously fed during the practice of (a).

Also (b) is typically practiced to print mailing media pieces of different size by referencing the leading 39 and top 38 edges of the mailing media pieces 37 using a sensor 36, and in response to that sensing the print heads 21 are controlled by the computer 25 through the interface 33 so as to properly position and space the indicia elements 42-44 taking into account the length of the media (in direction 40, that is the distance between the leading and trailing edges 39, 41 in FIG. 4).

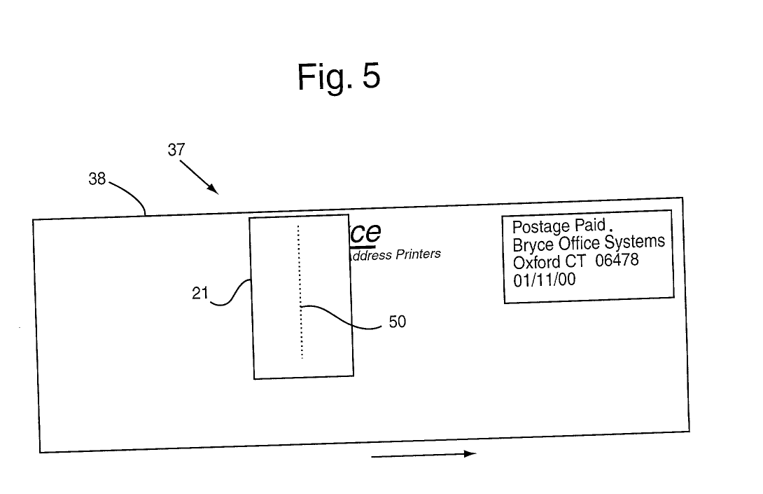

Referring to FIG. 5, which illustrates a print head overlying a mailing media piece 37 in position for printing, the print head is an extra-wide print head for printing an area up to 1.5 inches from the top edge 38 of the mailing media piece 37. As conventional, the print head 21 includes a plurality of nozzles 50 spaced from one another in a row extending generally perpendicular to the top edge 38 of the mailing media piece 37. By using a wide print head of this type, a substantially enlarged area, for example, up to and including 1.5 inches from the top edge of the mailing media piece can be printed.

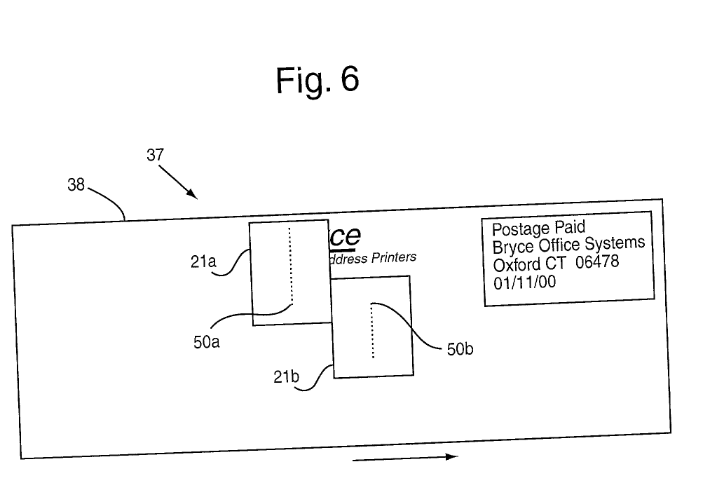

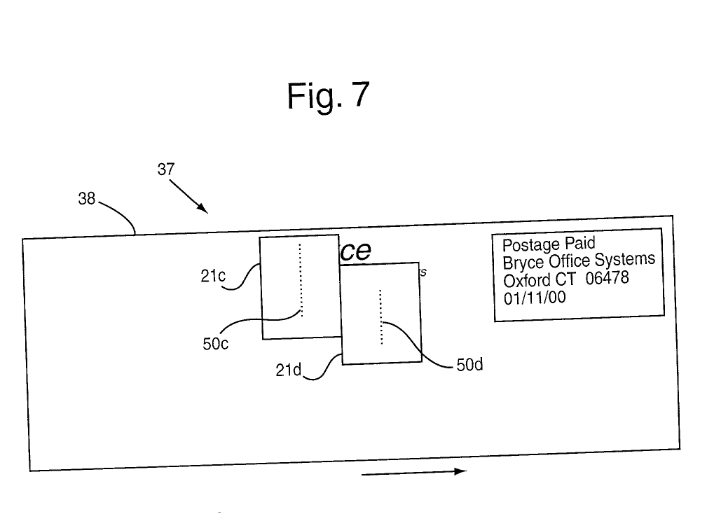

Referring to FIG. 6, there is illustrated a similar arrangement, however, using two or more print heads, two small conventional high-speed print heads 21a and 21b being preferred in this and in the embodiment of FIG. 7. Each of the print heads 21a and 21b includes a row of spaced nozzles 50a and 50b. Thus, an increased area of the mailing media piece 37 can be printed by locating the high-speed print heads spaced from one another in a direction generally perpendicular to the top edge 38 of the mailing media piece 37. Note that the lowermost nozzle 50a of the print head 21a closest to the top edge 38 is spaced from the uppermost nozzle 50b of the nozzles of the print head 21b a distance corresponding to the spacing between the nozzles of the print heads. As a consequence, a continuous printing area, e.g., up to and including 1.5 inches from the top edge 38 can be provided without interruption and which printed area will appear as if printed by a single print head as in FIG. 5.

Referring now to FIG. 7, there is illustrated a pair of print heads 21c and 21d, similar to print heads 21a and 21b in FIG. 6. The print heads 21c and 21d have rows of nozzles 50c and 50d, the nozzles of each print head being equally spaced from one another. Note in this embodiment, however, that certain of the nozzles of 50c overlap or lie in alignment with certain of the nozzles 50d in the direction of travel of the mailing media piece. The main system board 34 of FIG. 3 controls the nozzles of the print heads 21c and 21d to disable one set of the one or more overlapping nozzles of the print heads such that a continuous area may be printed on the mailing piece media without interruption. Thus, the spacing of the enabled nozzles of the print heads 21c and 21d are equal to one another such that a continuous line of printing from the uppermost nozzle of print head 21c to the lowermost nozzle of print head 21d may be accomplished without overlapping inks.

The invention also may be used for postage canceling, by controlling the print heads 21 using the computer 25 to provide a suitable canceling pattern.

It will thus be seen that according to the present invention a highly versatile and advantageous method and apparatus of and for printing multifarious postage information on mailing media of a wide variety of types, have been provided.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of printing multifarious postage information on mailing media having a top edge and left and right edges, using an ink jet printer with first and second ink jet heads and a feeder, and an internal computer for controlling the ink jet printer and feeder, comprising:
(a) by internal computer control of the feeder, automatically and continuously feeding mailing media pieces one at a time to the ink jet printer so that the top, left and right edges of the mailing media are positioned in printing relationship with the first and second ink jet heads;
(b) by external computer control of the ink jet printer, providing variable information to the internal computer of the ink jet printer and variably printing at least two of postage or postal permit information, a return address, and graphics in appropriate locations adjacent the top edge of the mailing media on the fly, so that one piece of mailing media has different indicia adjacent the top edge thereof than a leading or trailing piece of mailing media continuously fed to the ink jet printer;
(c) arranging the first and second ink jet heads contiguously to one another to print on respective different areas spaced from one another in a direction generally perpendicular to the top edges of the mailing media pieces so that a combined printed area on the mailing media pieces is greater than the printing area of any one of the print heads individually.

2. A method according to claim 1 wherein each of said print heads has a plurality of nozzles equally spaced from one another in a direction generally perpendicular to the top edges of the mailing media pieces, and including the step of spacing said print heads from one another, enabling a last nozzle of said first ink jet head to be spaced from a first nozzle of said second ink jet head in a direction away from said top edges a distance corresponding to the spacing between the nozzles whereby the printing areas of said first and second ink jet print heads do not overlap one another.

3. A method according to claim 1 wherein each of said ink jet print heads has a plurality of nozzles, and including the step of overlapping certain of the nozzles of said first ink jet head with certain of the nozzles of said second ink jet head in a direction of the feed of the mailing media pieces.

4. A method according to claim 3 including controlling the internal computer to disable the overlapping nozzles of said first ink jet head.

5. A method as recited in claim 1 wherein (a) and (b) are practiced at a rate of at least 100 pieces of mailing media per minute.

6. A method as recited in claim 5 wherein (b) is practiced to print substantially anywhere between the left and right edges of the mailing media pieces adjacent the top edge thereof.

7. A method as recited in claim 6 wherein (a) and (b) are practiced to print media having variable thickness ranging from single thickness sheets or labels to stuffed envelopes.

8. A method as recited in claim 7 wherein (b) is practiced to print on mailing media pieces of different size by referencing the leading and top edges of the mailing media pieces.

9. A method as recited in claim 1 wherein (b) is practiced to print mailing media pieces of different size by referencing the leading and top edges of the mailing media pieces.

10. A method as recited in claim 9 wherein (a) and (b) are further practiced so that the leading edge of each of the mailing media pieces is the right edge thereof.

11. A method as recited in claim 1 wherein (a) and (b) are practiced to print on stuffed envelopes as the mailing media at a rate of at least 200 envelopes per minute.

12. Apparatus for printing multifarious postage information on mailing media having a top edge and left and right edges, comprising:
an ink jet printer with first and second ink jet heads;
a feeder which feeds mailing media pieces one at a time into operative printing position with respect to the ink jet heads, said first and second ink jet heads being carried by said printer to print on respective different areas along the mailing media pieces spaced from one another in a direction generally perpendicular to the top edges thereof so that a combined printed area is greater than the printing area of each of the print heads individually; and
a computer external to said ink jet printer and said feeder for controlling the ink jet printer and feeder so as to variably print on the fly at least two of postage or postal permit information, a return address, and graphics at appropriate locations adjacent the top edge of the mailing media pieces.

13. Apparatus according to claim 12 wherein each of said print heads has a plurality of nozzles equally spaced from one another in a direction generally perpendicular to the top edges of the mailing pieces, the spacing of said print heads from one another enabling the last nozzle of said first ink jet print head to be spaced from the first nozzle of said second ink jet head in a direction perpendicular to said top edges a distance corresponding to the spacing between the nozzles whereby the printing areas of said first and second ink jet print heads do not overlap one another.

14. Apparatus according to claim 12 wherein each of said ink jet print heads has a plurality of nozzles, certain of the nozzles of said first ink jet head overlapping certain nozzles of said second ink jet head in a direction perpendicular to the top edges of the mailing pieces.

15. Apparatus according to claim 14 including means for controlling the internal computer to disable the overlapping nozzles of one of said first and second ink jet heads.

16. Apparatus as recited in claim 12 further comprising a thickness adjustment for adjusting the ink jet printer to accommodate mailing media pieces ranging in thickness from substantially flat labels or sheets to stuffed envelopes.

17. Apparatus as recited in claim 12 further comprising a sensor for sensing the leading and top edges of the mailing media to provide information to the computer to thereby properly control the location of printing on the mailing media.

18. Apparatus as recited in claim 12 wherein the printer, feeder, and computer are all capable of printing mailing media at a rate of at least 100 pieces per minute, and wherein the computer controls the printer to print all of graphics, return address, and either postage or postal code information, on each pieces of mailing media with at least one different from one piece to the next while being continuously fed by the feeder.
